(19) United States
(12) Patent Application Publication
(10) Pub. No.: US 2026/0298361 A1
(43) Pub. Date: Oct. 1, 2026

(54) VALVE CORE ASSEMBLY, THERMOSTATIC EXPANSION VALVE, AND REFRIGERATION SYSTEM

(71) Applicant: Zhejiang DUNAN Artificial Environment Co., Ltd., Zhejiang (CN)

(72) Inventors: Liefeng TU, Zhejiang (CN); Huanqiang SUN, Zhejiang (CN); Xiongwei RUAN, Zhejiang (CN)

(21) Appl. No.: 19/483,373

(22) PCT Filed: Apr. 1, 2024
(86) PCT No.: PCT/CN2024/085217

§ 371 Date: Nov. 11, 2025

(30) Foreign Application Priority Data
May 11, 2023 (CN) 202321153845.5

(51) Int. Cl. F16K 27/02; F25B 41/31

(52) U.S. Cl. CPC F16K 27/02; F25B 41/31

(57) ABSTRACT

Provided are a valve core assembly, a thermostatic expansion valve, and a refrigeration system. The valve core assembly includes a housing and a valve core; the valve core is mounted on the housing the housing is provided with a protruding part; the protruding part and the housing are integrally formed; and the protruding part is used for being welded to a valve body. According to the valve core assembly provided by the present disclosure, by integrally forming the protruding part and the housing, during production of the thermostatic expansion valve, the valve body can be directly welded to the protruding part, without using an inlet adapter, so that a welding process between the housing and an inlet adapter is avoided, thereby simplifying the production process of the thermostatic expansion valve.

### CROSS-REFERENCE TO RELATED APPLICATION

The present disclosure claims priority to Chinese Patent Application No. 202321153845.5, filed on May 11, 2023 and titled “Valve Core Assembly, Thermostatic Expansion Valve, and Refrigeration System”, which is incorporated herein by reference in its entirety.

### TECHNICAL FIELD

The present disclosure relates to a valve core assembly, a thermostatic expansion valve, and a refrigeration system.

### BACKGROUND

In a refrigeration cycle of an air conditioning apparatus, components such as a compressor, a condenser, a thermostatic expansion valve, and an evaporator are typically provided. Among these, the thermostatic expansion valve is commonly used as a throttling component in air conditioning and refrigeration equipment, which may throttle and reduce pressure of a liquid refrigerant from the condenser, and may regulate flow rate of the refrigerant from the condenser to the evaporator according to temperature at an outlet of the evaporator, to adapt to constantly changing refrigeration load.

In the related art, the thermostatic expansion valve includes a valve body and a valve core component. The valve core component includes a housing that is welded to the valve body via an inlet adapter. Specifically, first welding is required at a connection between one end of the inlet adapter and the housing to seal this connection; the other end of the inlet adapter is configured to be connected with a connecting pipe; subsequently, second welding is performed between the valve body and the inlet adapter, which consequently leads to a complex production process and high cost for the thermostatic expansion valve.

### SUMMARY

The present disclosure aims to provide a valve core assembly, a thermostatic expansion valve, and a refrigeration system, to solve the technical problem of complex production process for the thermostatic expansion valve in the related art.

According to an aspect of the present disclosure, there is provided a valve core assembly, including a housing and a valve core. The valve core is mounted in the housing, the housing is provided with a protruding part, the protruding part is integrally formed with the housing, and the protruding part is configured to be welded to a valve body.

According to an embodiment of the present disclosure, the protruding part is formed between two ends of the housing by stamping.

According to an embodiment of the present disclosure, the protruding part includes a flange and a folded edge, the flange is configured to be welded to the valve body, and the folded edge is integrally formed with the flange.

According to an embodiment of the present disclosure, the housing includes a first housing and a second housing, the first housing is integrally formed with the flange, the second housing is integrally formed with the folded edge, the valve core is mounted in the first housing, and the second housing is configured to be directly connected to a connecting pipe.

According to an embodiment of the present disclosure, the housing and the protruding part are formed by sheet material stretching.

According to an embodiment of the present disclosure, the housing includes a first housing and a second housing, the protruding part is in a plate shape, and the protruding part is integrally formed between the first housing and the second housing.

According to an embodiment of the present disclosure, the protruding part is an annular protrusion.

Based on the above objective, the present disclosure further provides a thermostatic expansion valve, including a valve body and the valve core assembly. The valve body is welded to the protruding part.

According to an embodiment of the present disclosure, the thermostatic expansion valve further includes a connecting pipe that is directly connected to the housing.

Based on the above objective, the present disclosure further provides a refrigeration system including the thermostatic expansion valve.

### BRIEF DESCRIPTION OF THE DRAWINGS

The above and other features and advantages of the present disclosure will become clearer by describing the exemplary embodiments in detail with reference to the accompanying drawings.

FIG. 1 is a schematic structural view of a valve core assembly according to an embodiment of the present disclosure;

FIG. 2 is a schematic structural view of a housing in a valve core assembly according to an embodiment of the present disclosure;

FIG. 3 is a partially enlarged view at A in FIG. 2;

FIG. 4 is a schematic structural view illustrating cooperation between a valve core assembly and a connecting pipe according to an embodiment of the present disclosure;

FIG. 5 is another schematic structural view of a housing in a valve core assembly according to an embodiment of the present disclosure;

FIG. 6 is a schematic structural view of a thermostatic expansion valve according to an embodiment of the present disclosure;

FIG. 7 is a schematic diagram of a refrigeration system according to an embodiment of the present disclosure.

### REFERENCE NUMERALS

100-housing; 101-first housing; 102-second housing; 200-protruding part; 201-flange; 202-folded edge; 300-spring base; 400-connecting pipe; 500-valve body; 600-compressor; 700-evaporator; 800-condenser; 900-temperature-sensing bulb.

### DETAILED DESCRIPTION

Exemplary embodiments will be now described more fully with reference to the accompanying drawings. However, the exemplary embodiments may be implemented in a variety of forms and should not be construed as being limited to the embodiments set forth herein. Although relative terms such as “above” and “below” are used herein to describe the relationship of one component relative to another component, such terms are used herein only for the sake of convenience, for example, in accordance with exemplary orientations depicted in the accompanying drawings. It can be understood that if the referenced device is inversed upside down, a component described as “above” will become a component described as “below”. Other relative terms such as “top” and “bottom” also have similar meanings. When a structure is described as “above” another structure, it probably means that the structure is integrally formed on another structure, or the structure is “directly” disposed on another structure, or the structure is “indirectly” disposed on another structure through an additional structure.

Terms “one,” “a/an,” “the” and “said” are used herein to indicate the presence of one or more elements/component parts/and others. Terms “including” and “having” have an inclusive meaning which means that there may be additional elements/component parts/and others in addition to the listed elements/component parts/and others. Terms such as “first” and “second” are used herein only as markers and do not limit the number of objects modified after them.

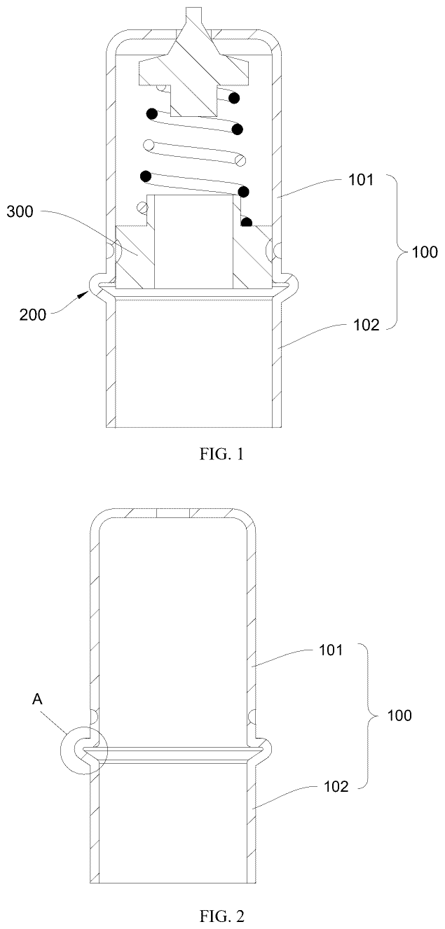

Referring to FIGS. 1 to 6, embodiments of the present disclosure provide a valve core assembly, including a housing 100 and a valve core (not shown). The valve core is mounted in the housing 100. The housing 100 is provided with a protruding part 200. The protruding part 200 is integrally formed with the housing 100. The protruding part 200 is configured to be welded to a valve body 500.

Based on this structure, for the valve core assembly according to the embodiments, by integrally forming the protruding part 200 with the housing 100, the valve body 500 may be directly welded to the protruding part 200 during production of an thermostatic expansion valve, without requiring an inlet adapter, which may avoid welding process between the housing 100 and the inlet adapter, thereby simplifying the production process of the thermostatic expansion valve.

Additionally, by eliminating the inlet adapter and the welding process between the housing 100 and the inlet adapter, production costs can be reduced to a certain extent.

In an embodiment, referring to FIG. 2, the protruding part 200 is formed between two ends of the housing 100 by stamping.

Exemplarily, a pipe material is stamped to form the housing 100 having the protruding part 200. It should be noted that the stamping process is known in the art and will not be described in detail herein.

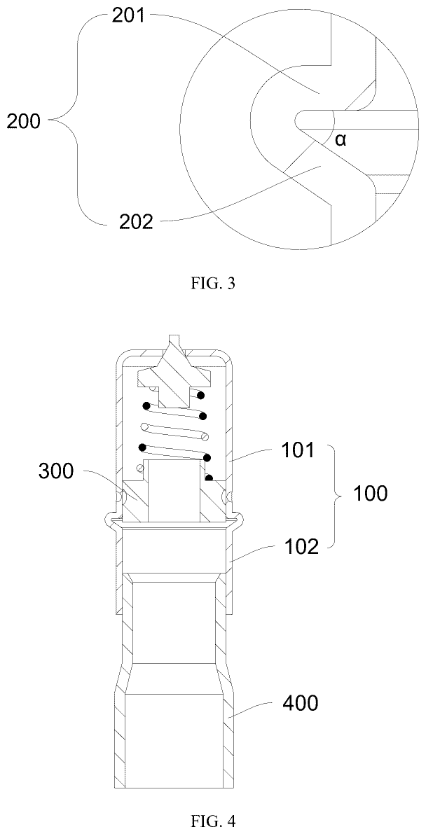

In an embodiment, referring to FIG. 3, the protruding part 200 includes a flange 201 and a folded edge 202. The flange 201 is configured to be welded to the valve body 500. The folded edge 202 is integrally formed with the flange 201.

Exemplarily, the flange 201 is in an annular flat plate shape to facilitate welding with the valve body 500.

Exemplarily, an angle a formed between the flange 201 and the folded edge 202 is greater than or equal to 0° and is less than 90°. For example, referring to FIG. 3, the angle α formed between the flange 201 and the folded edge 202 is an acute angle.

As another example, when the angle formed between the flange 201 and the folded edge 202 is 0°, the folded edge 202 is parallel to the flange 201 and is located below the flange 201, which may enhance the overall structural strength of the protruding part 200.

In some embodiments, the connection between the flange 201 and the folded edge 202 has a smooth transition, which may avoid stress concentration and reduce a risk of fracture.

In some embodiments, a radial width of the flange 201 is no less than 0.5 mm to ensure the welding strength between the flange 201 and the valve body 500.

In an embodiment, referring to FIGS. 1 and 4, the housing 100 includes a first housing 101 and a second housing 102. The first housing 101 is integrally formed with the flange 201. The second housing 102 is integrally formed with the folded edge 202. The valve core is mounted in the first housing 101. The second housing 102 is configured to be directly connected to the connecting pipe 400.

Exemplarily, the valve core assembly includes a spring base 300. The spring base 300 is welded to an inner wall of the first housing 101. The spring base 300 is provided with a spring.

It should be noted that the valve core, the spring, and the spring base 300 are known in the art, and their structures will not be described in detail.

In an embodiment, the protruding part 200 is an annular protrusion.

Exemplarily, a cross section of the housing 100 is circular in shape, and the protruding part 200 is disposed around the housing to form the annular protrusion, which may ensure a sealed connection between the valve body 500 and the valve core assembly during the welding process of the valve body 500 and the annular protrusion.

In other embodiments, the housing 100 and the protruding part 200 may also be formed by sheet material stretching.

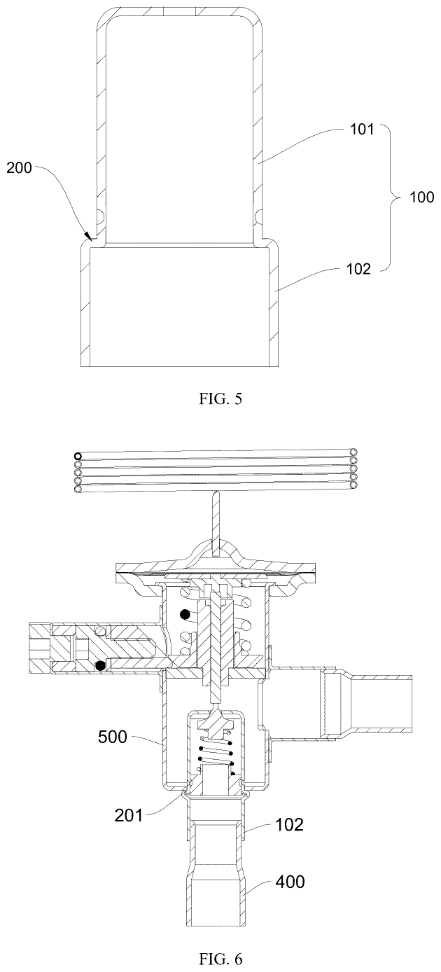

Exemplarily, when formed by the sheet material stretching, the housing 100 having the protruding part 200 as shown in FIG. 5 may be obtained.

In some embodiments, referring to FIG. 5, the housing 100 includes a first housing 101 and a second housing 102. The protruding part 200 is in a plate shape and is integrally formed between the first housing 101 and the second housing 102.

Exemplarily, the protruding part 200 is in an annular plate shape, and an inner ring edge of the protruding part 200 is integrally formed with the first housing 101, while an outer ring edge of the protruding part 200 is integrally formed with the second housing 102. The valve core is mounted in the first housing 101. The second housing 102 is configured to be directly connected to the connecting pipe 400.

It should be noted that a side wall of the second housing 102 may be perpendicular to or may not be perpendicular to the protruding part 200, which may be selected and configured by those skilled in the art according to actual requirements.

Embodiments of the present disclosure further provide a thermostatic expansion valve, including a valve body 500 and the valve core assembly according to the above embodiments. The valve body 500 is welded to the protruding part 200.

For the thermostatic expansion valve according to the embodiments, due to the use of the valve core assembly according to the above embodiments, the valve body 500 may be directly welded and fixed to the protruding part 200 during production of the thermostatic expansion valve, without requiring any inlet adapter, which may avoid welding process between the housing 100 and the inlet adapter, thereby simplifying the production process of the thermostatic expansion valve.

Additionally, by eliminating the inlet adapter and the welding process between the housing 100 and the inlet adapter, the production cost of the thermostatic expansion valve can be reduced to a certain extent.

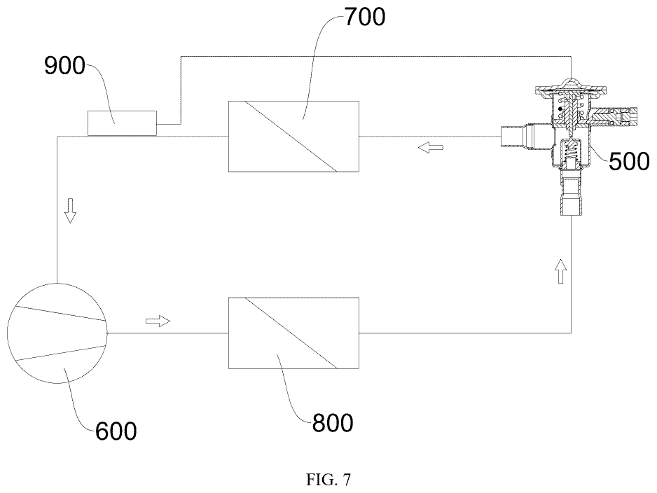

In an embodiment, referring to FIG. 6, the thermostatic expansion valve further includes a connecting pipe 400 that is directly connected to the housing 100.

Since the protruding part 200 is disposed between two ends of the housing 100, i.e., specifically, the protruding part 200 is integrally formed between the first housing 101 and the second housing 102, during production and assembly, the valve core is mounted in the first housing 101 and the connecting pipe 400 is directly welded to the second housing 102; exemplarily, an end of the connecting pipe 400 is directly welded to an inner wall of the second housing 102.

Referring to FIG. 7, embodiments of the present disclosure further provide a refrigeration system, including the thermostatic expansion valve according to the above embodiments.

Exemplarily, the refrigeration system further includes a compressor 600, an evaporator 700, and a condenser 800. A low-temperature and high-pressure liquid refrigerant from the condenser 800 forms low-temperature and low-pressure liquid refrigerant after being throttled and depressurized by the thermostatic expansion valve; then enters the evaporator 700, absorbs heat and evaporates within the evaporator 700, transforming into high-temperature and low-pressure gaseous refrigerant; afterwards enters the compressor 600 and transforms into high-temperature and high-pressure gaseous refrigerant; subsequently enters the condenser 800 and condenses into low-temperature and high-pressure liquid refrigerant within the condenser 800. In such a way, a refrigeration cycle is completed.

A temperature-sensing bulb 900 of the thermostatic expansion valve is provided at an outlet of the evaporator 700 or a suction section of the compressor, and is configured to sense a temperature at the outlet of the evaporator or the suction section of the compressor.

It should be noted that the working principle of the refrigeration system and the structure of the temperature-sensing bulb are known in the art and will not be described in detail herein.

For the refrigeration system according to the embodiments of the present disclosure, costs of the refrigeration system may be reduced to a certain extent due to the use of the thermostatic expansion valve according to the embodiments.

It should be understood that the present disclosure does not limit its application to the detailed structure and arrangement of the components mentioned in this specification. The present disclosure may have other embodiments and may be implemented and executed in various ways. The aforementioned variations and modifications fall into the scope of the present disclosure. It should be understood that the present disclosure, as disclosed and limited in this specification, extend to all alternative combinations of two or more individual features mentioned or apparent in the text and/or in the accompanying drawings. All of these different combinations constitute a plurality of alternative aspects of the present disclosure. The embodiments described in this specification illustrate the optimal ways known for implementing the present disclosure and will enable those skilled in the art to utilize the present disclosure.

1. A valve core assembly, comprising a housing and a valve core, wherein the valve core is mounted in the housing, the housing is provided with a protruding part, the protruding part is integrally formed with the housing, and the protruding part is configured to be welded to a valve body.

2. The valve core assembly according to claim 1, wherein the protruding part is formed between two ends of the housing by stamping.

3. The valve core assembly according to claim 2, wherein the protruding part comprises a flange and a folded edge, the flange is configured to be welded to the valve body, and the folded edge is integrally formed with the flange.

4. The valve core assembly according to claim 3, wherein the housing comprises a first housing and a second housing, the first housing is integrally formed with the flange, the second housing is integrally formed with the folded edge, the valve core is mounted in the first housing, and the second housing is configured to be directly connected to a connecting pipe.

5. The valve core assembly according to claim 1, wherein the housing and the protruding part are formed by sheet material stretching.

6. The valve core assembly according to claim 5, wherein the housing comprises a first housing and a second housing, the protruding part is in a plate shape, and the protruding part is integrally formed between the first housing and the second housing.

7. The valve core assembly according to claim 1, wherein the protruding part is an annular protrusion.

8-10. (canceled)

11. The valve core assembly according to claim 3, wherein an angle between the flange and the folded edge is greater than or equal to 0° and is less than 90°.

12. The valve core assembly according to claim 3, wherein a connection between the flange and the folded edge has a smooth transition.

13. The valve core assembly according to claim 3, wherein a radial width of the flange is no less than 0.5 mm.

14. The valve core assembly according to claim 4, wherein the valve core assembly further comprises a spring base that is welded to an inner wall of the first housing, and the spring base is provided with a spring.

15. The valve core assembly according to claim 1, wherein a cross section of the housing is circular in shape, and the protruding part is disposed around the housing to form an annular protrusion.

16. The valve core assembly according to claim 6, wherein an inner ring edge of the protruding part is integrally formed with the first housing, while an outer ring edge of the protruding part is integrally formed with the second housing.

17. A thermostatic expansion valve, comprising a valve body and a valve core assembly, wherein the valve core assembly comprises a housing and a valve core; the valve core is mounted in the housing; the housing is provided with a protruding part; the protruding part is integrally formed with the housing; and the protruding part is configured to be welded to the valve body.

18. The thermostatic expansion valve according to claim 17, further comprising a connecting pipe that is directly connected to the housing.

19. The thermostatic expansion valve according to claim 17, wherein the protruding part is formed between two ends of the housing by stamping.

20. The thermostatic expansion valve according to claim 19, wherein the protruding part comprises a flange and a folded edge, the flange is configured to be welded to the valve body, and the folded edge is integrally formed with the flange.

21. The thermostatic expansion valve according to claim 20, wherein the housing comprises a first housing and a second housing, the first housing is integrally formed with the flange, the second housing is integrally formed with the folded edge, the valve core is mounted in the first housing, and the second housing is configured to be directly connected to a connecting pipe.

22. The thermostatic expansion valve according to claim 17, wherein the housing and the protruding part are formed by sheet material stretching.

23. A refrigeration system, comprising a thermostatic expansion valve, wherein the thermostatic expansion valve comprises a valve body and a valve core assembly;
the valve core assembly comprises a housing and a valve core; the valve core is mounted in the housing; the housing is provided with a protruding part; the protruding part is integrally formed with the housing; and the protruding part is configured to be welded to the valve body.
